(19) United States
(12) Patent Application Publication
(10) Pub. No.: US 2012/0074128 A1
(43) Pub. Date: Mar. 29, 2012

(54) HEAT MANAGEMENT SYSTEM

(75) Inventors: Michael E. "Woody" Blackford, Portland, OR (US); Lane Cobb, Portland, OR (US); Jeffrey Mergy, Portland, OR (US); Anya Gorson, Portland, OR (US); Daniel W. Crist, Portland, OR (US)

(73) Assignee: Columbia Sportswear North America, Inc., Portland, OR (US)

(21) Appl. No.: 13/225,122

(22) Filed: Sep. 2, 2011

Related U.S. Application Data
(60) Provisional application No. 61/379,705, filed on Sep. 2, 2010.
(60) Provisional application No. 61/483,390, filed on May 6, 2011.

(51) Int. Cl. H05B 1/02

(52) U.S. Cl. 219/487; 219/483; 219/486

(57) ABSTRACT

Embodiments disclosed herein relate generally to the field of outerwear, and more particularly to a heat management system configured to provide heat to one or more predetermined regions or zones, such as the upper or lower body, torso, chest, back, neck, arms, shoulders, wrists/cuffs, hands, fingers, feet, toes, and the like. In various embodiments, these heating zones may be controlled by an actuator switch and control electronics that may allow individual heating zones to be actuated alone or in combination, and in some embodiments, in a predetermined sequence. Some embodiments of the actuator switch may include color-coded lighting elements that may indicate the current temperature, zone activation, heating program, and the like.

### CROSS REFERENCE TO RELATED APPLICATIONS

The present application claims priority to U.S. Provisional Patent Application No. 61/379,705, filed Sep. 2, 2010, entitled “HEAT MANAGEMENT SYSTEM, METHOD AND APPARATUS,” and U.S. Provisional Patent Application No. 61/483,390, filed May 6, 2011, entitled “ZONED HEAT MANAGEMENT SYSTEM,” the disclosures of which are hereby incorporated by reference in their entirety.

### TECHNICAL FIELD

Embodiments disclosed herein relate generally to the field of outerwear, and more particularly to a heat management method and system configured to provide heat to all or part of an article of outerwear, such as in regions or zones, for instance the upper or lower body, torso, chest, back, neck, arms, shoulders, wrists/cuffs, hands, fingers, feet, toes, and the like.

### BACKGROUND

Outerwear such as jackets, gloves, footwear, and the like may be used for a variety of outdoor activities that take place in colder temperatures. As a result of physiological factors and/or mental perceptions, the passive insulating systems of existing insulated outerwear may not be sufficient to keep the wearer of the outerwear sufficiently warm. Accordingly, various manufacturers have included heating components in outerwear to augment the passive warming systems. However, existing outerwear heating systems have been deficient for many reasons, with the most common issues being the difficulty of manufacturing an integrated system that is safe, durable, and does not unduly hamper the performance of the outerwear or the user's use thereof; the difficulty of providing a reliable, user friendly system; the difficulty of providing a system that is customizable and user-controllable for a variety of different body types, uses, and environmental conditions; and the difficulty of providing a system that is economically practical to include in outerwear.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates an example of a heat management system used in a jacket, in accordance with various embodiments;

FIG. 2 illustrates an enlarged portion of various components of the heat management system of FIG. 1, in accordance with various embodiments;

FIG. 3 illustrates an enlarged portion of various components of the heat management system of FIG. 1, in accordance with various embodiments;

FIG. 4 illustrates a component diagram of a heat management system that may be used in jackets, in accordance with various embodiments;

FIG. 5 illustrates an activation switch for a heat management system, in accordance with various embodiments;

FIGS. 6A and 6B illustrate views of a heat management system as used in gloves, in accordance with various embodiments;

FIG. 7 illustrates a component diagram of a heat management system as used in gloves, in accordance with various embodiments;

FIG. 8 illustrates a component diagram of a heat management system as used in footwear, in accordance with various embodiments; and

FIG. 9 illustrates a component diagram of a heat management system, in accordance with various embodiments.

### DETAILED DESCRIPTION OF EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Embodiments of the present disclosure may be directed to outerwear such as jackets, gloves, pants, footwear, hats, and the like. In various embodiments, a heat management system may be integrated into outerwear, and may be adapted to controllably heat the entirety of the article of outerwear, or desired zones in the outerwear, to keep a user warm in colder climates. In various embodiments, the system may include heating elements and electrical couplings/leads that may be integrated into the outerwear, or that may be integrated into a liner that may be coupled to the outerwear, and that may further include active components such as one or more power packs and/or a separate controller (for instance, control electronics (CE)). Various embodiments may also include a central interface that may coordinate the electrical connections between the various components.

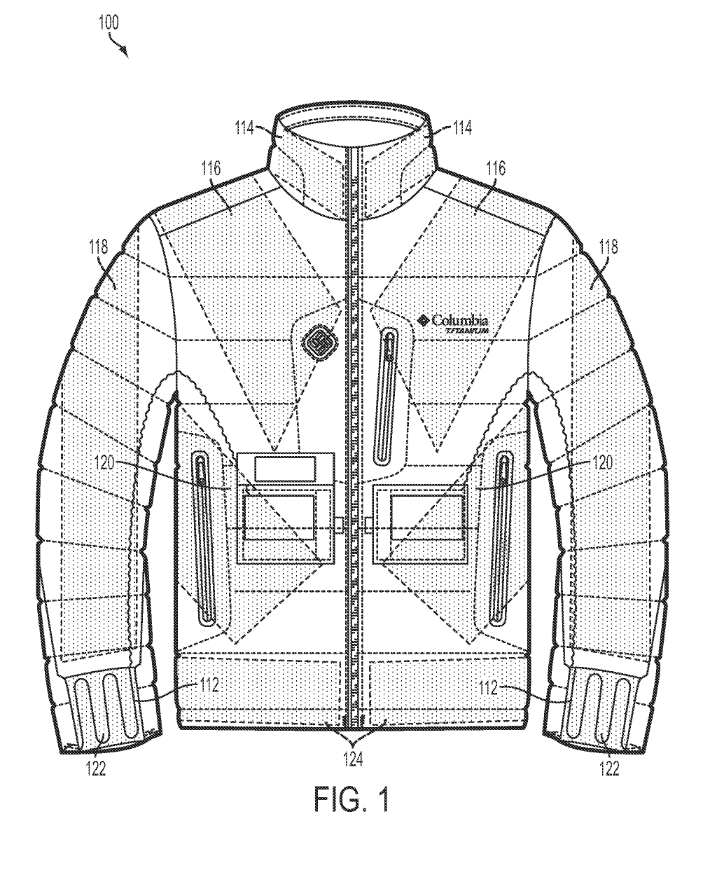

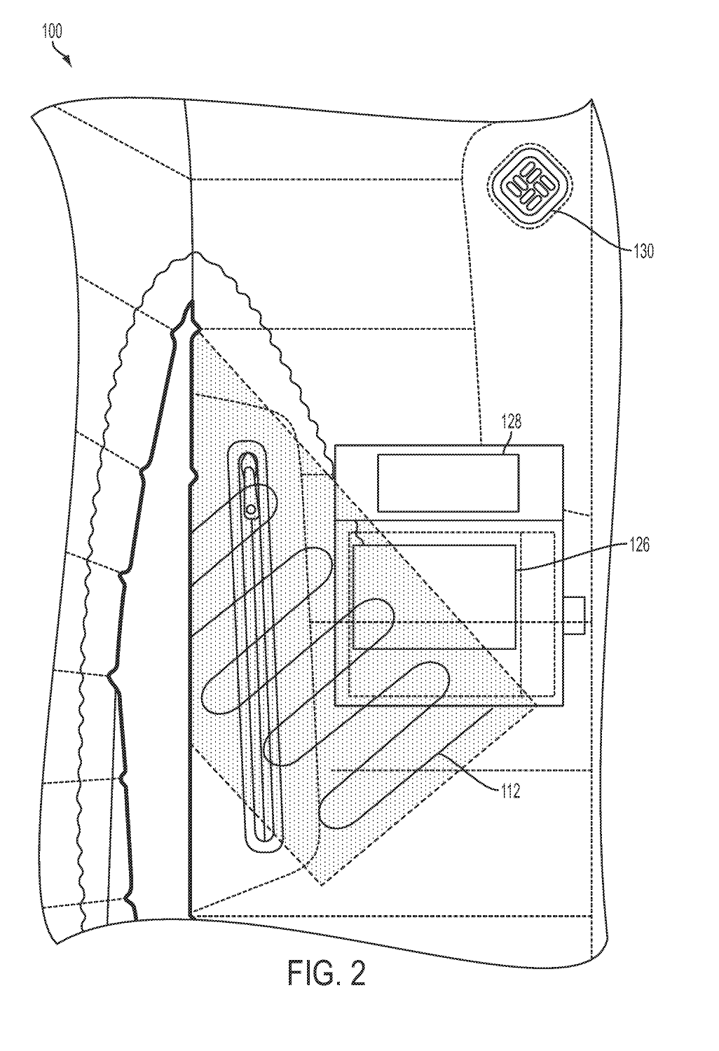

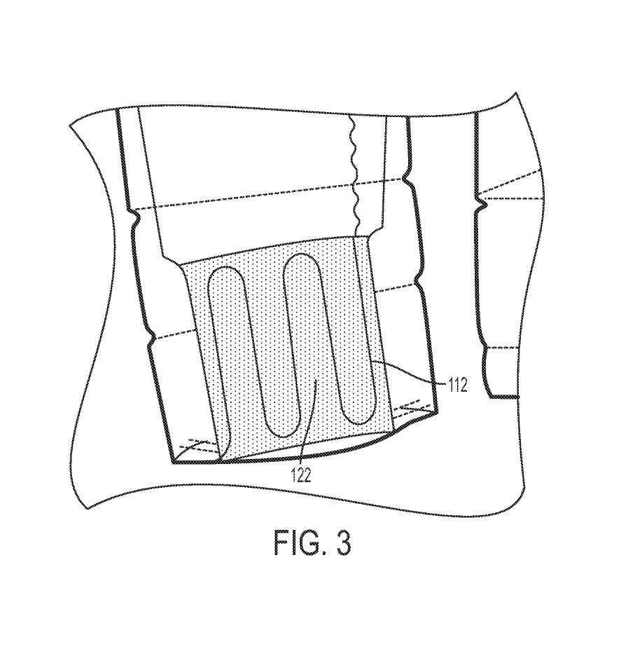

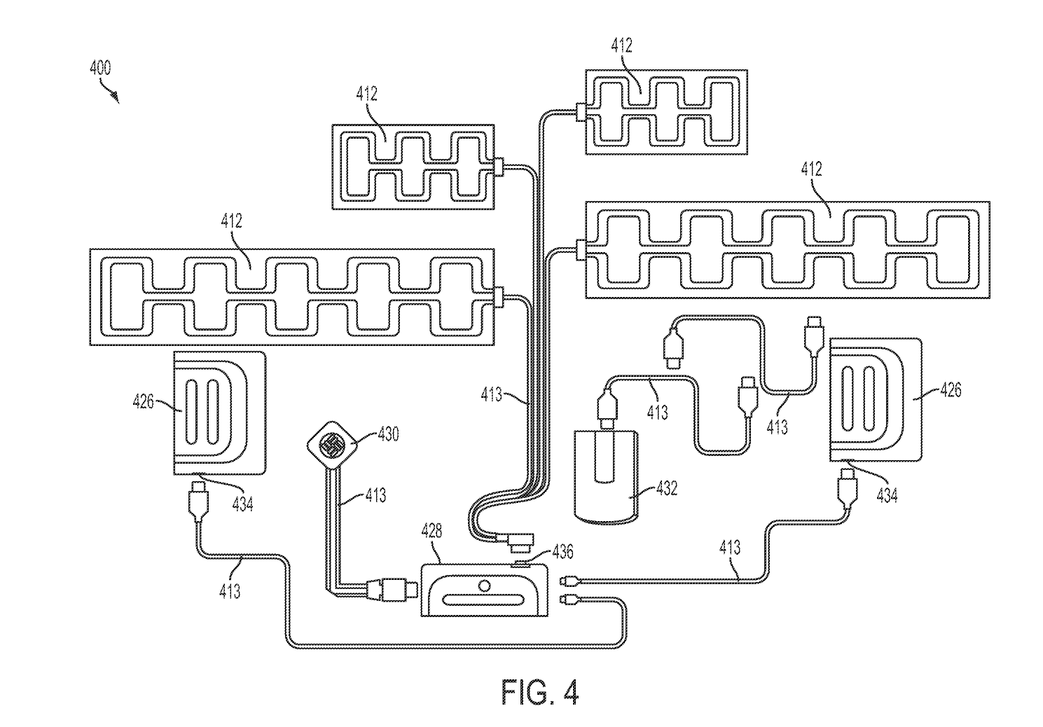

FIG. 1 illustrates an example of a heat management system used in a jacket; FIG. 2 illustrates an enlarged portion of various components of the heat management system of FIG. 1; FIG. 3 illustrates an enlarged portion of various components of the heat management system of FIG. 1; and FIG. 4 illustrates a component diagram of a heat management system that may be used in, for instance, jackets, all in accordance with various embodiments.

As shown in FIG. 1, in various embodiments, a heat management system 100 may include one or more heating elements 112 that may be coupled to the outerwear (e.g., a jacket), and that may be designed to provide heat to all or most of the outerwear, or to designated areas or zones 114, 116, 118, 120, 122, 124. In some embodiments, two or more of zones 114, 116, 118, 120, and 124 may be separately controllable, which, as used herein, means that heating of the zones may be activated and/or controlled independently of one another, for instance, in terms of heating duration or intensity. Thus, in various embodiments, system 100 may be configured to provide heat to the body of the user in a desired body region or regions. Although a jacket is illustrated in this example, one of skill in the art will appreciate that heat management system 100 may be configured for use in any of a number of types of outerwear, such as coats, hats, gloves, mittens, vests, pants, overalls, leggings, shoes, boots, and the like. Similarly, zoned heat management system 100 may also be configured for use in other types of clothing, such as socks, underwear, long underwear, undershirts, and the like.

In various embodiments, heating element 112 may include a single element or a group of elements (for example, alloy-based, carbon fiber yarn, etc.) that may be integrated into a carrier layer for coupling to the jacket fabric. In other embodiments, heating elements 112 may be woven directly into a layer of the jacket or outerwear, or disposed between various layers.

In various embodiments, heating elements 112 may be positioned in a variety of different zones in the outerwear, such as in the in the neck/collar zone 114, in the shoulder/chest zone 116, in the arm zone 118, in the torso/mid-section zone 120, in the cuff zone 122, and/or in the waist/hip zone 124. Although zones 114, 116, 118, 120, 122, and 124 are illustrated in FIG. 1, one of skill in the art will appreciate that heating zones may be created in any part of the jacket, such as in the front or back portion of the jacket, and in some embodiments, separate heating elements may be provided on the left and right sides of the jacket. In various embodiments, fewer or more zones may be included in the jacket than are illustrated in FIG. 1. In some embodiments, a single zone, such as torso/mid-section zone 120, may serve to warm more than one body part, such as the torso and also the hands (when placed in the pockets). In other embodiments, a single zone may encompass all or most of the jacket.

In various embodiments, heating elements 112 may be selectively actuatable by the user such that only a portion of the elements (e.g., a single zone or pre-selected group of zones) may be actuated at a given time. In other embodiments, heating elements 112 may be actuatable in a predetermined sequence. For example, in one specific, non-limiting example, a user may initially select (or system 100 may be configured to automatically provide) heating in the torso/mid-section zone 120, arm zone 118, neck/collar zone 114, and cuff zone 122. After the initial warming phase, the user may select (or the system may be configured to automatically provide) heating in just a subset of the zones, such as in just the torso/mid-section zone 120, just the arm zone 118, or in a combination of zones, such as arm zone 118 and cuff zone 122.

In some embodiments, heating elements 112 may be removable and repositionable in different locations within the jacket (e.g., using a hook and loop type attachment mechanism, pockets, snaps, etc.) such that a user may customize heating zone placement for their own body type, environmental conditions, or personal preferences. In various embodiments, heating elements 112 may include temperature sensors that may interrupt the heating of heating elements 112 if an uncomfortable or unsafe temperature is reached.

FIG. 2 illustrates an enlarged portion of several components of the heat management system of FIG. 1. As shown in FIG. 2, various embodiments of system 100 also may include one or more power supplies 126 (e.g., power/battery packs) that may be removably coupled to system 100, for example, attached to the outerwear or disposed in a pocket. Various embodiments also may include a control element 128 electrically coupled to power supply 126 and heating element 112, and an actuator button or switch 130 configured to activate and/or control one or more operations of system 100.

FIG. 3 illustrates an enlarged portion of the cuff region of the jacket shown in FIG. 1. As illustrated in FIG. 3, heating element 112 may be configured to provide heat to the wrist/cuff zone 122 of the outerwear. In specific, non-limiting embodiments, heating element 112 may be positioned within the cuff such that axial stretching of the cuff is permitted without interference from heating element 112.

FIG. 4 illustrates an exemplary component diagram of a heat management system that may be used in jackets or other outerwear/apparel. For example, as shown in FIG. 4, in some embodiments, the system 400 may include a power supply 426 that may include a charging port 434, which may be a USB or micro USB port in some embodiments, for instance for facilitating charging of power supply 426 via USB or micro USB connector elements on conduits 413. In some embodiments, power supply 426 and/or control electronics 428 also may include an auxiliary port, such as a USB or micro USB port (not shown), which may allow system 400 to be programmed by a user, or may be adapted to allow for the powering of one or more external components, such as an MP3 player (not shown). In some embodiments, charging port 434 and the auxiliary port may be one and the same. In various embodiments, a power-out port 436 may be included to supply power to heating elements 412 (for example, via control electronics 428), and in some embodiments, power-out port 436 may be of a configuration that may supply a greater voltage than is attainable through charging port 434 and/or the auxiliary port.

In various embodiments, power supply 426 also may include a charge indicator to indicate the amount of charge remaining in the power supply. In some embodiments, power supply 426 may include a charge indicator (not shown) on more than one side of the pack, for instance in order to enhance visibility by the user regardless of its placement in the outerwear. Also, because batteries tend to decrease in performance as temperature decreases, in various embodiments (e.g., as illustrated), power supply 426 may be positioned proximal to (e.g., adjacent, near, or overlapping) heating element 412, which may serve the purpose of helping to keep power supply 426 warm and enhance performance. In various embodiments, power supply 426 may further be coupled to a household type plug wall charger 432 or a separate battery power source, such as a vehicle or laptop, for charging.

In various embodiments, control electronics 428 may be removably positioned in the jacket or other outerwear, and may be separable from power supply 426. In various embodiments, control electronics 428 may include electronic components that may help control/regulate the disposition of power, voltage, current, etc. from power supply 426 to heating elements 412, control activation of desired heating zones, activate a predetermined sequence of heating zone activation, and/or balance or regulate the use of multiple power supplies 426. In various embodiments, control electronics 428 also may include any of a variety of safety controls, such as temperature sensors and shut-off features, power supply malfunction detectors, heating element malfunction detectors, thermostats, timing circuits, and the like. Further, in some embodiments, control electronics 428 may include a “dry mode” which can allow the control unit to activate heating elements 412, for example while the power supplies 426 are charging, in order to facilitate drying of the outerwear.

In some embodiments of system 400, control electronics 428 may be housed in a separate unit from power supply 426. In specific, non-limiting embodiments, separating control electronics 428 from power supply 426 may have advantages, such as an improved ability to clean the outerwear. In various embodiments, separation of control electronics 428 from power supply 426 may also allow for additional heating elements 412 and/or power supplies 426 to be used, may allow for greater flexibility to control heating zones as desired, and may better manage power among different power supplies 426. In specific, non-limiting embodiments, the passive components such as heating elements 412 and the electrical couplings/wires/conduits 413 may be integrated into the outerwear by the outerwear manufacturing company, while the active components such as power supply 426 and control electronics 428 may be later installed by the user and/or retailer. In some embodiments, this may reduce manufacturing complexities and reduce shipping costs.

As described above, various embodiments of system 400 may include electrical conduits 413, traces, or couplings, such as alloy based wiring, carbon fibers, and the like. In some embodiments, electrical conduits 413 may be coupled to the outerwear in order to electrically couple heating elements 412 to the power supply. In specific, non-limiting embodiments, carbon fiber may be used in outerwear due to its durability and ability to be integrated into and/or stitched with fabric and to function in moist environments.

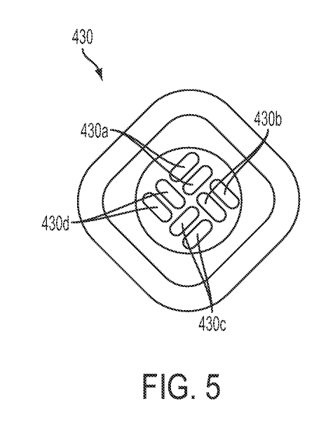

FIG. 5 illustrates a detailed view of a specific, non-limiting example of actuator switch 430, which may be coupled to control electronics 428 and/or power supply 426 (see, e.g., FIG. 4), and may be configured to provide a user interface for activating and controlling heat management system 400. As shown in FIG. 5, in various embodiments, actuator switch 430 may allow the user to selectively control the zone, temperature, and/or duration of activation, and/or it may be used to actuate a predetermined heating zone sequence. For instance, in some embodiments, a predetermined heating zone sequence may include first heating all heating zones, and after a predetermined time or once a predetermined temperature has been reached, only a subset of the heating zones may continue to be actuated.

For instance, in one specific, non-limiting example, in the jacket embodiment illustrated in FIG. 1, all of zones 114, 116, 118, 120, 122, and 124 may be actuated initially, and after a predetermined amount of time or when a predetermined temperature is reached, only zones 116 and 120, or only zones 114 and 122 (or another zone or combination of zones) may continue to be actuated. In some embodiments, system 400 may be configured to turn off after a predetermined amount of time. In other embodiments, a heating zone sequence may include two, three, four or more zones and/or temperature settings. In particular embodiments, such a sequence may be customizable by a user to suit personal preferences, environmental conditions, and/or special needs.

In some embodiments, actuator switch 430 may be illuminated (e.g., back lit or illuminated with LEDs) such that it may help the user readily identify the selected zone or cycle (e.g., on/off, high, medium, low, etc.). In some embodiments, the color of illumination may change to indicate a temperature, zone, or other setting. In particular embodiments, such as the one shown in FIG. 5, actuator switch 430 may be in the shape of a logo or symbol and/or may include more than one illuminating element (e.g., 430a, 430b, 430c, and 430d) that may separately illuminate and/or may change color in order to indicate the selected zone, temperature, or cycle. In some embodiments, the illuminated actuator switch 430 may also enhance the visibility of the wearer in limited visibility conditions (e.g., darkness or low light, fog, rain, or snow). Illumination may be constant or flashing.

In some embodiments, if backlighting is not desired, actuator switch 430 or a component thereof may be actuated for a certain period (e.g., 3-10 seconds), such that the control unit may disable the illumination function. In various embodiments the illumination may be provided by colored LEDs, and in some embodiments, the illumination may be color coded to correspond with different heat levels, different heating zones, and/or different heating programs or sequences. In some embodiments, actuator switch 430 may include an automatic shutoff feature if it is depressed for an extended period of time (e.g., 10-20 seconds), for example to keep the garment from accidentally overheating when, for example, left under a heavy object or packed in a suitcase, backpack or bag. In some embodiments, one or more illuminating elements (e.g., 430a, 430b, 430c, and 430d) may be separately actuatable, for example to actuate different zones or to raise or lower the temperature in one or more heating elements.

As discussed above, in the specific embodiment illustrated in FIG. 1, while heating elements 112 may be strategically positioned in a variety of zones, some heating zones suited to particular uses may include the cuff zone 122, torso/mid-section zone 120, and/or neck/collar zone 114. For example, in the detailed view illustrated in FIG. 3, heating element(s) 112 may be disposed in a cuff of a jacket, for example, so as to keep the wrist and upper hand area warm. It has been found that this is a particularly sensitive body area, and by heating the cuff region, it may help enhance the user's perception of being warm, particularly in the hands, which may have poor circulation. For example, in some embodiments, heating elements 112 in cuff zones 122 may help keep the blood warm that goes to the hands, which in turn may help keep the hands/fingers warm. In particular embodiments (not shown), the cuffs may be a “gluff” type heating element, which may have a thumb hole that can help keep the cuff heating element properly oriented, while continuing to provide good dexterity and comfort to the user. In various embodiments, the connection between the electrical conduits 113 carrying the power to cuff zones 122 may be offset from the cuff heating element 112 so that the user does not appreciably feel the bulk of the connector. In one embodiment, a fabric tab may extend from the cuff heating element and provide the connection platform.

In other specific embodiments, torso/mid-section zone 120 may be located in the rib cage or torso area of the body, as it has been found that heating in this region can sufficiently warm, or provide the perception of sufficient warmth for much of, the upper body. In one embodiment, as illustrated in FIG. 1, placement of power supply 126 in the forward mid-torso region where the ribs converge may be an advantageous location, as it positions power supply 126 close to heating elements 112 in torso/mid-section zone 120 in the rib cage/torso region, which may keep power supply 126 warm to improve performance. Such a position may also allow for better balancing, and/or the provision of a similar feeling/perception of a cell phone, MP3 player, or other device being located in the pocket. As mentioned above, such a positioning may also serve to heat the user's pockets.

In other embodiments, heating elements 112 may be disposed about the collar/neck zone 114 of the jacket in order to help keep the wearer warm in an area that tends to be where much of the cold air initially infiltrates a jacket. In particular embodiments, a combination of neck/collar zones 114 and cuff 122 zones may be employed either alone, or in sequence or in combination with other heating zones.

In various embodiments, power supply 126 and control electronics 128 may be removable from the outerwear, and heat management system 100 may be scalable for the user's comfort and may provide added flexibility. For example, additional power supplies 126 may be included for longer heating periods; more heating elements 112 may be activated, such as a collar/neck zone 114, back zone (not shown), cuff zone 124, etc. Further, in some embodiments, a separate controller 128 may be adapted to selectively activate the desired heating elements 112 alone or in combination with other desired heating elements 112 to tailor the warmth to a user's needs. For example, in specific, non-limiting embodiments, heating elements 112 in cuff zone 122 may be activated without the torso/mid-section zone 120 being activated.

In various embodiments, to improve manufacturability, the components of heat management system 100, such as heating elements 112 and electrical conduits 113, may be coupled to a liner that may be independent from the main outerwear fabrication (e.g., jackets or other outerwear). The liner may then be coupled to the outerwear (e.g., stitched, zipped, buttoned, hook-and-loop closure, etc.) by the jacket manufacturer, retailer or user. In various embodiments, this may cut down on the complexity of integrating those components directly with the outerwear, and may also improve the maintenance of the outerwear, by, for example, allowing the liner to be removed and the outerwear cleaned.

In some embodiments, control electronics 128 and/or power supply 126 may be directly coupled to a DC or AC system to directly power heating elements 112. In one embodiment, outerwear power supplies 126 may be coupled to a motor cycle, boat or vehicle's 6 or 12 volt DC system in order to directly power heating elements 112. In various embodiments, power supplies 126 may be rechargeable through solar panels disposed on the power packs, or other locations on the outerwear.

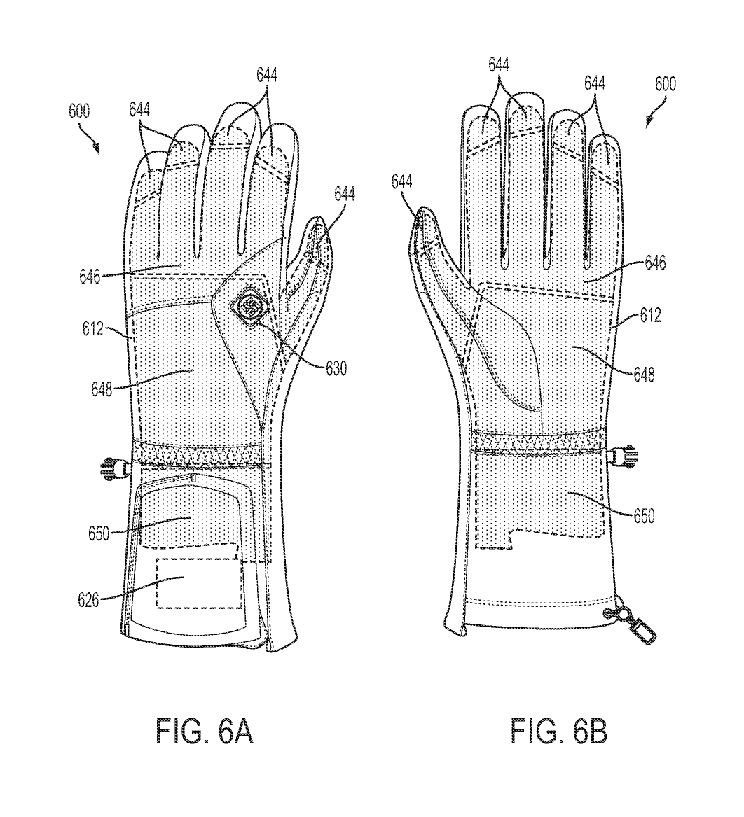

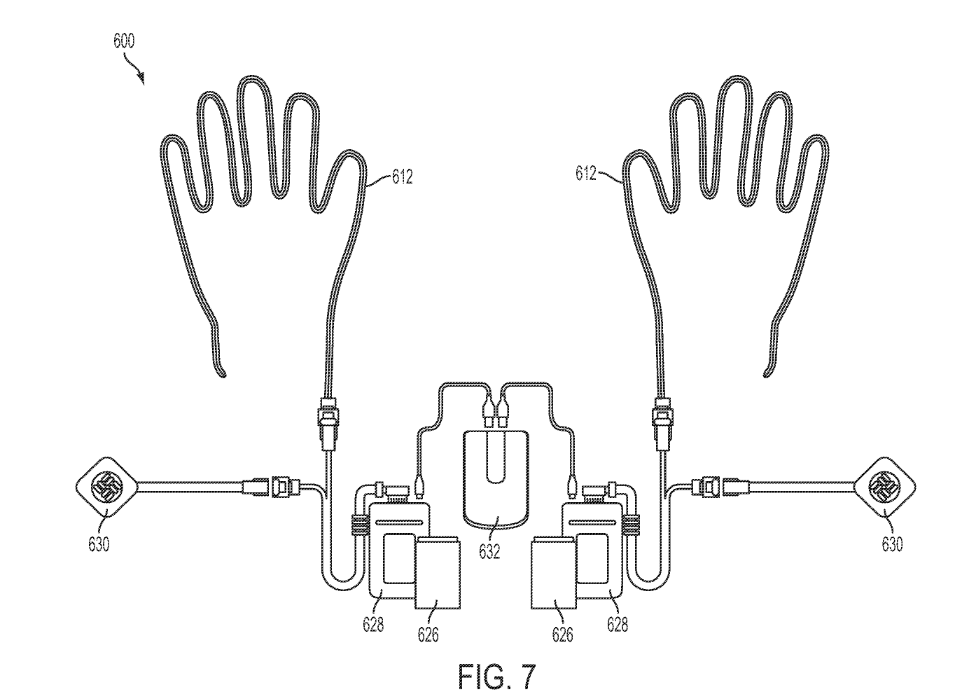

FIGS. 6A, 6B, and 7 illustrate views and diagrams of heat management systems 600 used in conjunction with outerwear such as gloves. While many of the embodiments discussed above may be applicable to gloves, these illustrations show a particular embodiment. In one specific, non-limiting example, as shown in FIGS. 6A and 6B, a power supply 626 may be removably positioned in a glove cuff, for example in a pocket. In some embodiments, such as the illustrated embodiment, individual heating zones 644, 646, 648, 650, may be arranged in the fingertips (644), fingers (646), palm/back of hand (648), and/or wrist (650). In other embodiments, the glove may have a different number and/or arrangement of heating zones, such as a single heating zone encompassing the entire glove, or positioned at the fingers only. In specific, non-limiting examples, an actuator switch 630 may be positioned in any convenient location, such as on the back of the glove.

As illustrated in FIG. 7, in specific, non-limiting embodiments, system 600 may include a power supply 626 that may be removably docked in a control electronics unit 628 to form a single power/control unit. In some embodiments, this unit may be removably housed in a pocket in or toward the wrist area of the gloves. In various embodiments, heating element 612 (e.g., a single wire element or multiple wire elements) may traverse the perimeter of the hand along the fingers. In some embodiments, an electrical coupling may be made between power supply 626 and heating element 612. In various embodiments, power supply 626 may be coupled to a wall charger 632 to charge power supply 626 in both the left and right gloves at the same time. In some embodiments, an actuator switch 630 may control the temperature and duration of activation as described above with reference to other embodiments.

Although a particular embodiment is shown in FIGS. 6A, 6B, and 7, wherein heating element 612 includes a single element that travels along the periphery of the glove, in various embodiments, multiple heating elements 612 may also be arranged in separately-controllable zones, such as zones 644, 646, 648, and 650. As described above for jackets, these separately-controllable zones may be activated individually or in sequence essentially as described above, for example by control electronics 628 and an actuator switch 630.

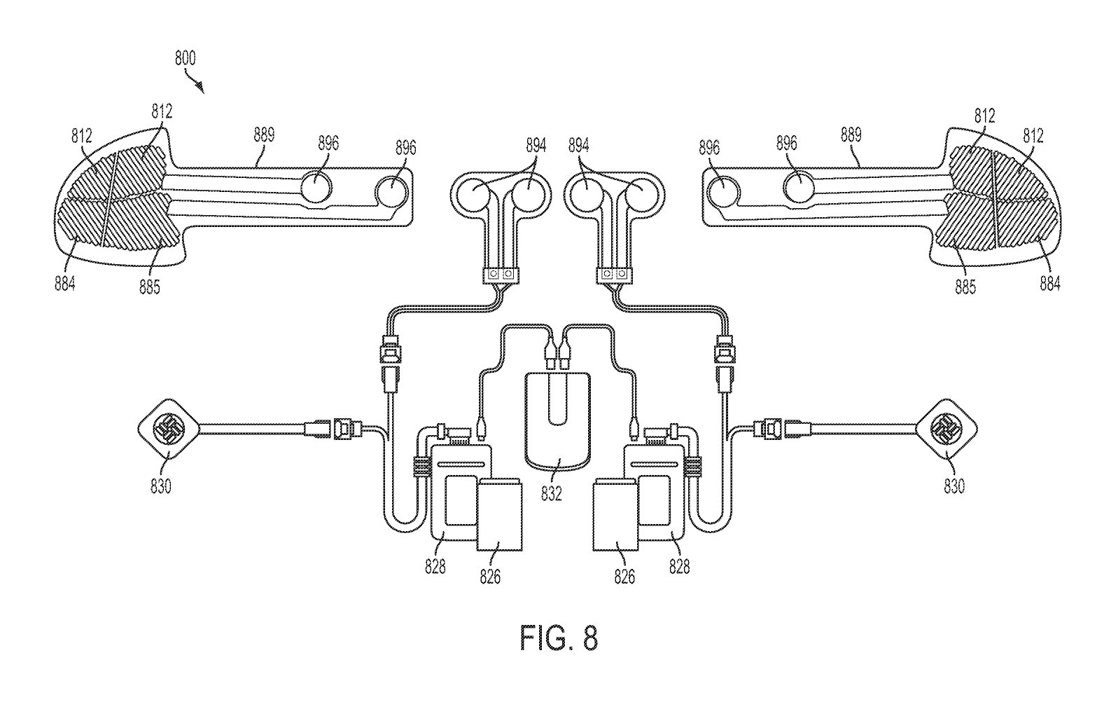

FIG. 8 illustrates a component diagram of a heat management system 800 that may be used in conjunction with outerwear such as footwear. While many of the embodiments discussed above are applicable to footwear, this illustration shows a particular embodiment. As shown, a power supply 826 may be removably docked in a control electronics unit 828 to form a power/control unit. In various embodiments, the power/control unit may be removably housed in a pocket in or above the ankle area of the footwear. In some embodiments, heating element 812 may be disposed in or take the form of a removable sock liner 889, and in some embodiments, may be positioned in a desired location of sock liner 889. For example, in some embodiments, heating element 812 may lie under the foot, and may be positioned in the front of the foot, back of the foot, or may essentially line the entire footbed in various embodiments.

In various embodiments, an electrical coupling may be made between power supply 826 and heating element 812 through connectors/contacts 894, 896 in the midsole or the like and the under side of sock liner 889. As previously described, in various embodiments, power supplies 826 may be coupled to a wall charger 832 to charge system 800 in each footbed/sock liner at the same time. In various embodiments, an actuator switch 830 may control the temperature and duration of activation. Although the illustrated example heats only zones in the forefoot (e.g., zones 884, 885), one of skill in the art will appreciate that system 800 may be configured to heat other areas of the foot, including the whole footbed. As described above for gloves and jackets, zones may be separately controlled individually or in sequence. Additional details of a footwear heat management system are disclosed in co-pending application 61/258,554, which is incorporated herein by reference in its entirety.

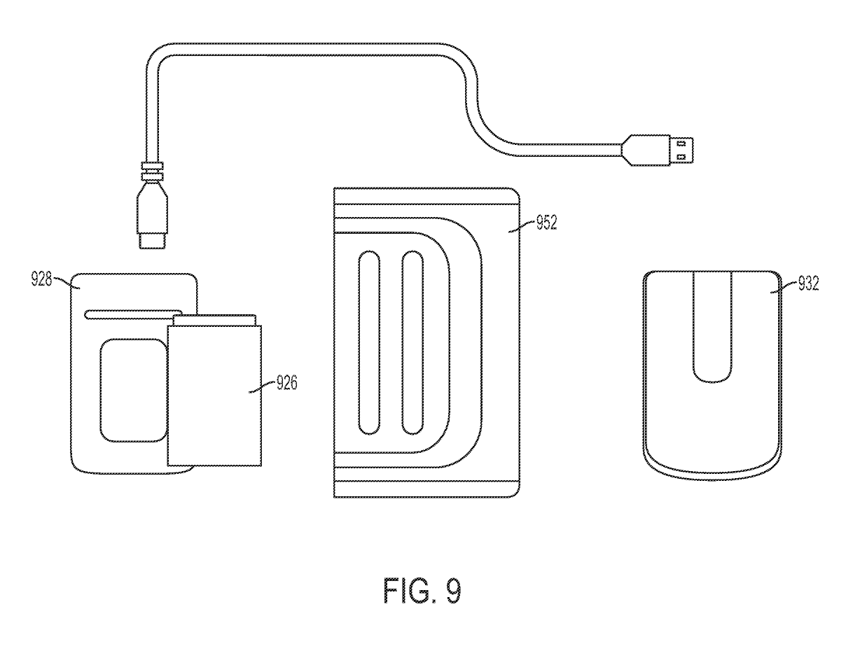

FIG. 9 illustrates examples of a power supply 926 and related components that may be used in heat management systems in accordance with various embodiments. In specific, non-limiting examples, the control electronics unit 928 may couple to a power supply 926, and may include a wireless function, which may enable control electronics unit 928 to be controlled by a remote control unit 952. As described above, a charging unit 932 also may be provided for charging power supply 926. In some embodiments, remote control unit 952 may be configured to couple to one or more control electronics units on multiple different pieces of outerwear and allow selective control of the one or more control electronics units of the various outerwear articles (e.g., jacket, gloves, footwear).

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments in accordance with the present disclosure may be implemented in a very wide variety of ways. This application is intended to cover any adaptations or variations of the embodiments discussed herein. Therefore, it is manifestly intended that embodiments in accordance with the present disclosure be limited only by the claims and the equivalents thereof.

We claim:

1. A heat management system comprising:
a heating element configured to be disposed in an outerwear article;
a power supply configured to be disposed in the outerwear article and adapted to removably couple to and supply power to the heating element;
a control electronics unit configured be disposed in the outerwear article, wherein the control electronics unit is configured to control a supply of power to the heating element; and
an actuator switch coupled to the control electronics unit, and adapted to actuate the heat management system to provide heat to one or more pre-selected zones of the outerwear article.

2. The heat management system of claim 1, wherein the system comprises a plurality of heating elements.

3. The heat management system of claim 2, wherein the heating elements are separately controllable.

4. The heat management system of claim 3, wherein the heating elements are disposed in different zones in the outerwear article.

5. The heat management system of claim 4, wherein the outerwear article is a jacket and the different zones are selected from the group consisting of a neck/collar zone, a shoulder zone, an upper chest zone, an abdominal zone, a torso zone, a front zone, a rear zone, a waist zone, a hip zone, an arm zone, and a cuff zone.

6. The heat management system of claim 5, wherein the different zones comprise a neck/collar zone and a cuff zone.

7. The heat management system of claim 4, wherein the outerwear article is a glove, and wherein the different zones are selected from the group consisting of a finger zone, a palm zone, a thumb zone, a wrist zone, a proximal finger zone, and a distal finger zone.

8. The heat management system of claim 4, wherein the outerwear article is a footwear article and wherein the different zones are selected from the group consisting of a toe zone, a forefoot zone, a midfoot zone, a heel zone, an instep zone, and an ankle zone.

9. The heat management system of claim 4, wherein the control electronics unit is configured to independently control power to each zone.

10. The heat management system of claim 9, wherein the control electronics unit is configured to activate the heating elements in a predetermined sequence.

11. The heat management system of claim 1, wherein the heating element is disposed in a lining layer of the outerwear article.

12. The heat management system of claim 1, wherein the actuator switch comprises an indicator light configured to indicate a system or heating element state.

13. The heat management system of claim 1, wherein the actuator switch comprises an indicator light configured to produce light of a plurality of colors, and wherein the light is color-coded to indicate a system or heating element state, a temperature of a heating element, or activation of a heating zone heating sequence.

14. The heat management system of claim 1, wherein the actuator switch comprises a plurality of separately actuatable switches and a corresponding plurality of separately actuatable indicator lights.

15. The heat management system of claim 14, wherein the separately actuatable switches are configured to actuate heating elements in different zones of the outerwear article, a plurality of temperature settings for the heating elements, or a plurality of predetermined heating zone actuation sequences.

16. The heat management system of claim 14, wherein the separately actuatable indicator lights are configured to indicate the actuation of heating elements in different zones of the outerwear article, the actuation of a temperature setting for a heating element, or the actuation of a predetermined heating zone actuation sequence.

17. A zoned heat management system comprising:
a heating element configured to be disposed in an outerwear article;
a power supply adapted to couple to and supply power to the heating element;
a control electronics unit configured be disposed in the outerwear article, wherein the control electronics unit is configured to control a supply of power to the heating element; and
an actuator switch configured to removably couple to the control electronics unit, and adapted to actuate the zoned heat management system;
wherein the system comprises a plurality of separately controllable heating elements; wherein the outerwear article comprises a jacket, a glove, or a footwear article;
wherein the actuator switch comprises an indicator light configured to produce light, and wherein the light indicates a system or heating element state, a temperature of a heating element, or activation of a heating zone heating sequence.

18. A method of heating an article of outerwear, comprising:
providing a heating element configured to be disposed in an outerwear article;
providing a power supply configured to be disposed in the outerwear article and adapted to removably couple to and supply power to the heating element;
providing a control electronics unit configured be disposed in the outerwear article, wherein the control electronics unit is configured to control a supply of power to the heating element;
providing an actuator switch coupled to the control electronics unit, and adapted to actuate the heat management system; and
actuating the actuator switch to provide heat to one or more pre-selected zones of the outerwear article.

19. The method of claim 18, wherein providing a heating element configured to be disposed in an outerwear article comprises providing a plurality of heating elements configured to be disposed in different zones in the outerwear article.

20. The method of claim 18, wherein actuating the actuator switch to provide heat to one or more pre-selected zones of the outerwear article comprises actuating one or more of the plurality of separately controllable heating elements.
